(19) United States
(12) Patent Application Publication
(10) Pub. No.: US 2009/0303990 A1
(43) Pub. Date: Dec. 10, 2009

(54) Off-Chip Interface for External Routing

(75) Inventors: Thomas Phillip Ambrose, Costa Mesa, CA (US); Hal Hao Chan, Costa Mesa, CA (US); Stuart Bruce Berman, Costa Mesa, CA (US)

Correspondence Address: EMULEX DESIGN & MANUFACTURING CORPORATION;C/O MORRISON & FOERSTER LLP, 555 WEST FIFTH STREET, SUITE 3500, LOS ANGELES, CA, 90013, US

(73) Assignee: Emulex Design & Manufacturing Corporation

(21) Appl. No.: 12/135,017

(22) Filed: Jun. 6, 2008

(51) Int. Cl. H04L 12/56

(52) U.S. Cl. 370/389

(57) ABSTRACT

The use of routing logic within a single ASIC to save space, along with a way to modify and/or supplement the routing logic after the ASIC has been fabricated is disclosed. This is accomplished by providing a programmable “detour” or external router interface to allow for off-chip state machine portions or other external routing logic to be accessed. With this external router interface, additional routing modes or features that were not planned before the release of the ASIC can be implemented after release. The on-chip centralized routing logic may operate on incoming frames, and selectively operate on certain areas in the header to make the route. The off-chip state machine portions can complement the on-chip routing logic by working with the on-chip router, or replace certain portions of it.

### FIELD OF THE INVENTION

This relates generally to network switches contained in application specific integrated circuits (ASICs), and more particularly, for providing routing features and capabilities that are partitioned between two ASICs that allows the ability to add capability to a single routing ASIC through additional functions implemented by a second ASIC.

### BACKGROUND OF THE INVENTION

Network switches are generally capable of connecting a number of devices to each other through a switch core such as a crossbar switch. In order to create a proper route through the crossbar switch, the crossbar switch must be programmed by routing logic in accordance with packets received by the switch from the network. There are several conventional approaches to the hardware implementation of network switches. In one approach, the network switch is a combination of a switch and a routing function on a single ASIC. In another approach, the switch function is in a separate ASIC from the routing function. One drawback to these approaches is that the routing capability is completely defined when it is fabricated in an ASIC. These approaches both create implementation challenges when new features and capabilities are subsequently defined after the ASIC has been fabricated. Implementation of those new routing features and capabilities cause the re-fabrication of the ASIC, including the high cost and significant delay associated with the redesign activities.

Therefore, there is a need to employ routing features and capabilities, yet provide a way to modify or supplement the routing features and capabilities after the ASIC has been fabricated.

### SUMMARY OF THE INVENTION

This relates to employing routing logic within a single ASIC to save space, and also providing a way to modify and/or supplement the routing logic after the ASIC has been fabricated. This is accomplished by providing a programmable “detour” or external router interface to allow for off-chip state machine portions or other external routing logic to be accessed. With this external router interface, additional routing modes or features that were not planned before the release of the ASIC can be implemented after release. The on-chip centralized routing logic may operate on incoming frames, and selectively operate on certain areas in the header to make the route. The off-chip state machine portions can complement the on-chip routing logic by working with the on-chip router, or replace certain portions of it. In order for the off-chip logic to be accessed, certain areas (fields) within the incoming packets may be utilized, and if those fields contain certain values, the packets can be routed to the off-chip routing logic. The data in these fields can include all data necessary to make the correct routes.

By providing an external routing interface to the switching device, core routing features and capabilities can be designed quickly and partitioned into the first router ASIC early enough to meet aggressive time-to-market needs, yet allow for changes to routing requirements after the ASIC has been fabricated as marketing or standards change using external routing logic. In addition, off-chip routing logic can handle additional routing functions for improved security (authentication and encryption) and quality of service, and deeper levels of zoning support, advanced broadcast and multicast support, and SCSI frame replication and mirroring functions.

Optionally, when a frame is received at a port control module (PCM), a programmable finite state machine (FSM) may take parts of the frame header that are used to determine a route and store them as part of a route request within the PCM. The route request can include the requesting source port, the source address, the destination address, priority information, the frame data type, and the direct route enable bit. Other fields from deeper in the frame or from elsewhere in the device may also be captured to enable more advanced routing capabilities. For example, the original Ethernet headers from a Fibre Channel Over Ethernet (FCoE) packet, or security and encryption information from the FC-SP header fields can be captured as part of the route request.

Once complete, the route request can be forwarded to the router over a route request bus, which may utilize a finite state machine (FSM) to determine the appropriate route, generate route programming information, and program a crossbar switch via programming lines. The router may then send a response back to the PCM, which can then forward the packets of data to the crossbar switch.

In embodiments of the invention, a port is provided to allow the router to connect to an off-chip device such as a router extension through an off-chip route request bus. The router extension may include one or more FSMs. When the router extension is used, FSMs in the on-chip router may, in some embodiments, operate on one part of the header of the frame, while FSMs in the router extension can operate on a different part of the header. The FSM in the on-chip router can read the route request from the PCM and, depending on what is found in the header fields, either determine the route itself or forward the route request on to the FSM in the router extension. Some of the features that can be made available using previously undefined header fields and the router extension include routing based on zones, source/destination pairs, source/destination attributes, security associations, and the type or class of commands (e.g. SCSI commands, class of service, etc.).

After the route request is processed by the external and/or internal routers, a route response may be returned from the external router. The route response may include the response type (e.g. router OK, rejected, discard, busy, forced disconnect, etc.), the reason code (needed for reject, busy, discard), the source port, the destination port, and the timer value.

### BRIEF DESCRIPTION OF THE DRAWINGS

FIG. 1 illustrates an exemplary Fibre Channel (FC) switch including a router extension port according to embodiments of the invention.

FIG. 2 illustrates an exemplary Fibre Channel Over Ethernet (FCOE) switch employing off-chip routing according to embodiments of the invention.

FIG. 3 illustrates a flow diagram of an exemplary finite state machine (FSM) in an on-chip router capable of utilizing off chip routing logic according to embodiments of the invention.

FIG. 4 illustrates an exemplary denial of service scenario that could be mitigated by the external router capabilities provided by embodiments of the invention.

FIG. 5 is a drawing of an exemplary FC frame with a FC header and payload (data) with a security header capable of being used by a router extension according to embodiments of the invention.

FIG. 6 illustrates an exemplary generalized network configuration including network switches having external router connections for connecting to external routing logic according to embodiments of the invention.

### DETAILED DESCRIPTION OF THE PREFERRED EMBODIMENTS

In the following description of preferred embodiments, reference is made to the accompanying drawings which form a part hereof, and in which it is shown by way of illustration specific embodiments in which the invention can be practiced. It is to be understood that other embodiments can be used and structural changes can be made without departing from the scope of the embodiments of this invention.

This relates to employing routing logic within a single ASIC to save space, and also providing a way to modify and/or supplement the routing logic after the ASIC has been fabricated. This is accomplished by providing a programmable “detour” or external router interface to allow for off-chip state machine portions or other external routing logic to be accessed. With this external router interface, additional routing modes or features that were not planned before the release of the ASIC can be implemented after release. The on-chip centralized routing logic may operate on incoming frames, and selectively operate on certain areas in the header to make the route. The off-chip state machine portions can complement the on-chip routing logic by working with the on-chip router, or replace certain portions of it. In order for the off-chip logic to be accessed, certain areas (fields) within the incoming packets may be utilized, and if those fields contain certain values, the packets can be routed to the off-chip routing logic. The data in these fields can include all data necessary to make the correct routes.

By providing an external routing interface to the switching device, core routing features and capabilities can be designed quickly and partitioned into the first router ASIC early enough to meet aggressive time-to-market needs, yet allow for changes to routing requirements after the ASIC has been fabricated as marketing or standards change using external routing logic. In addition, off-chip routing logic can handle additional routing functions for improved security (authentication and encryption) and quality of service, and deeper levels of zoning support, advanced broadcast and multicast support, and SCSI frame replication and mirroring functions.

Although embodiments of the invention may be described and illustrated herein in terms of FC and FCOE, it should be understood that embodiments of this invention are not so limited, but are additionally applicable to network switches for other protocols including, but not limited to, Ethernet, Multiroot IO virtualization (PCI Express switching), Serial Attached SCSI (SAS) and Serial ATA (SATA).

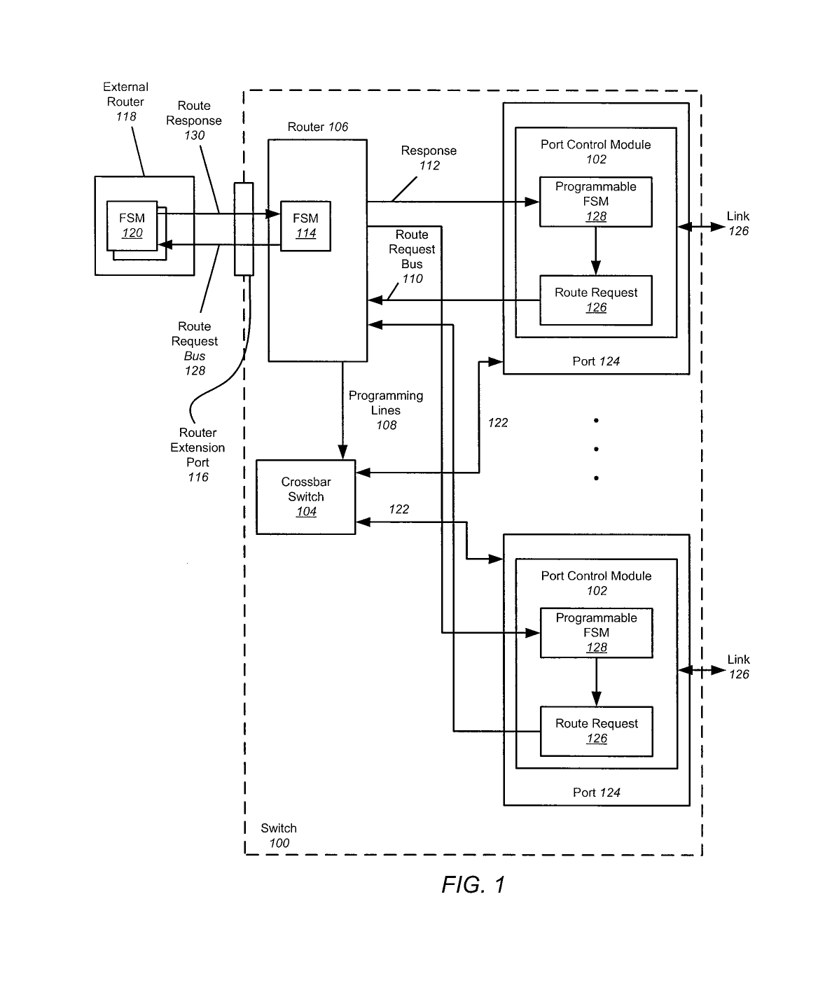

FIG. 1 illustrates an exemplary switch 100 including a router extension port 116 according to embodiments of the invention. In the example of FIG. 1, switch 100 can include a plurality of ports 124, each port containing a port control module (PCM) 102, each PCM coupled to a crossbar switch 104 and a router 106. Router 106 is coupled to crossbar switch 104 and is capable of programming the switch. In FC embodiments, each PCM 102 can be coupled to a FC link 126. Optionally, when a frame is received at a PCM 102, a programmable finite state machine (FSM) 128 may take parts of the frame header that are used to determine a route and store them as part of a route request 126 within the PCM. An exemplary FC switch (also referred to as a fabric), its use in an exemplary system, and the definition of a route request are described in U.S. Pat. No. 6,185,203, the contents of which are incorporated herein by reference in its entirety for all purposes.

The route request 126 can include the requesting source port, the source address, the destination address, priority information, the frame data type, and the direct route enable bit. An exemplary FC route request format is illustrated in Table 1.

TABLE 1
Route Request Format

| Byte | Description | | | |
|---|---|---|---|---|
| 1 | Delimiter Type [4:0] | rtdirect | rsvd | offchip |

| | | | |
|---|---|---|---|
| 00 = SOFc1 | 08 = SOFother | 10 = EOFn | 18 = EOFrti |
| 01 = SOFi1 | 09 = SOFnf | 11 = EOFt | 19:1F = 7 spare |
| 02 = SOFn1 | 0A = SOFc4 | 12 = EOFdt | |
| 03 = SOFi2 | 0B = SOFn4 | 13 = EOFdti | |
| 04 = SOFn2 | 0C = SOFi4 | 14 = EOFa | |
| 05 = SOFi3 | 0D:0F = 2 spare | 15 = EOFrt | |
| 06 = SOFn3 | | 16 = EOFni | |
| 07 = SOFf | | 17 = EOFother | |

| | |
|---|---|
| 2 | D_ID [7:0] or RTD ID [7:0] |
| 3 | D_ID [15:8] |
| 4 | D_ID [23:16] |
| n + 1 | R_CTL [7:0] |
| n + 1 | S_ID [7:0] |
| n + 1 | S_ID [15:8] |
| n + 1 | S_ID [23:16] |
| n + 1 | CS_CTL [7:0] |
| n + 1 | TYPE [7:0] |
| n + 1 | F_CTL [7:0] |
| n + 2 | F_CTL [15:8] |
| n + 3 | F_CTL [23:16] |

The route request may be sent in one or more transfers depending on the number of fields and the route request bus width, with optional fields shown in Table 1 italics. In the example of Table 1, the fields are:

Delimiter Type—A five-bit entry to indicate the start of frame (SOF) or end of frame (EOF) type. The mapping can be as indicated in the exemplary table above. The route rules use the type to help determine the correct route response.

Route Direct—This bit is set to indicate a route direct request. The route direct destination port is specified in the next byte.

OffChip—When set, this bit indicates that the router should send the route request off chip.

Route Direct ID/Port_ID/ALPA Destination ID—If a route direct request is made, this byte represents the destination port number. Bits 4-0 indicate the physical port on the chip.

Area Destination ID—If the switch is in fabric mode, this byte is the Area portion of the 24-bit address. In all other modes, this byte is zero.

Domain Destination ID—If the switch is in fabric mode, this byte is the Domain portion of the 24-bit address. In all other modes, this byte is zero.

Routing Control—If the option is enabled, the routing control field from the FC header is included for advanced routing features.

Source ID—If the option is enabled, the source ID of the requester is included for advanced features (S_ID based hardware zoning, quality of service, etc.).

Class Specific Control—If the option is enabled, the class specific/priority control information from the FC header is included for advanced routing features.

Type—If the option is enabled, the data structure type from the FC header is included for advanced routing features (e.g. video).

Frame Control—If the option is enabled, the frame handling control field from the FC header is included for advanced routing features.

Other fields from deeper in the frame or from elsewhere in the device may also be captured to enable more advanced routing capabilities. For example, the original Ethernet headers from a Fibre Channel Over Ethernet (FCOE) packet, or security and encryption information from the FC-SP header fields can be captured as part of the route request.

Once complete, the route request 126 can be forwarded to the router 106 over a route request bus 10, which may utilize a finite state machine (FSM) 114 to determine the appropriate route, generate route programming information, and program the crossbar switch 104 via programming lines 108. The router 106 may then send a response 112 back to the PCM 102, which can then forward the packets of data to the crossbar switch 104 through path 122.

In embodiments of the invention, port 116 is provided to allow the router 106 to connect to an off-chip device such as a router extension 118 through an off-chip route request bus 128. Router extension 118 may include one or more FSMs 120. When the router extension 118 is used, FSMs 120 may, in some embodiments, operate on one part of the header of the frame, while FSM 114 can operate on a different part of the header. FSM 114 can read the route request from PCM 102 and, depending on what is found in the header fields, either determine the route within FSM 114 or forward the route request on to FSM 120 in router extension 118. Some of the features that can be made available using previously undefined header fields and the router extension 118 include routing based on zones, source/destination pairs, source/destination attributes, security associations, and the type or class of commands (e.g. SCSI commands, class of service, etc.). The external router interface may require a few additional clocks above what is required for the internal router, but the clock speed may be fast enough such that that the additional latency does not impact the full bandwidth operation of all ports.

The on-chip router logic can include arbitration logic that allows for multiple modes of operation. In one embodiment, depending on certain fields in the route request, the internal router 106 can enter an “on-chip router only” mode and process the request by itself (e.g. a normal route). However, if the fields (e.g. a mode bit) indicate that the route request should be handled by the router extension 118, the internal router 106 can enter an “external mode only” mode and simply pass the route request along to the router extension 118. In a “mixed mode only” mode, the internal router can be used for its preprogrammed routing modes, and a programmable type field may be used to send specified routes to the external device. The internal and external routers 106 and 118 can work together in a mixed mode in a synchronized manner. If neither router determines that it can handle the route request, a message can be returned to that effect.

After the route request is processed by the external and/or internal routers, a route response 130 may be returned from the external router. The route response 130 may include the response type (e.g. router OK, rejected, discard, busy, forced disconnect, etc.), the reason code (needed for reject, busy, discard), the source port, the destination port, and the timer value. An exemplary Route Response Format is illustrated in Table 2.

TABLE 2
Route Response Format

| Bits | Description | |
|---|---|---|
| 31:24 | | Reserved [4:0] |
| 23:16 | Response action [1:0] | Response reason [4:0] |
| | 0 = Reserved | 00 = Reserved |
| | 1 = retryable | 01 = Frame Timeout |
| | 2 = non-retryable | 02 = Reserved |
| | 3 = Reserved | 03 = N_Port Temporarily not available |
| | | 04 = N_Port Permanently not available |
| | | 05 = Class is not supported |
| | | 06-1E = Reserved |
| | | 1F = routeOK |
| 15:8 | | Response Type [3:0] |
| | | 0 = routeOK |
| | | 1 = reject |
| | | 2 = busy |
| | | 3 = discard |
| | | 4-E = Reserved |
| | | F = disconnect UR |

| | |
|---|---|
| 7:0 | Reserved |

The route response can include information about the route rules result and special modes/configurations for the source port.

Response Action—if the result type is a reject, indicate to the source if it can try to transmit again.

Response Reason—When a reject occurs, the reason code is indicated here. The reasons may include:

Frame Timeout—the route is made and the data transfer should proceed;

N_Port Temporarily Not Available—the port is busy;

N_Port Permanently Not Available—the port is offline or HW zoned out;

Class is Not Supported—the port does not support the requested class; and

route OK—the route is OK.

Response Type—The types may include:

route OK—the route is made and the data transfer should proceed;

reject—a route is not made; check the reject action and reason code;

busy—a route is not made because the destination port is busy;

discard—a route is not made and the frame should be thrown away; and

disconnect timeout (unsolicited resp.)—when a route has been connected and disconnected within the timeout period, this reason is sent to the source port and the route is torn down.

Note that the FC standard teaches routing based on the destination identifier (D_ID), with security provided by routing based on the D_ID or source identifier (S_ID). However, it does not provide for security and routing based on routing control (R_CTL) (e.g., what kind of data stream it is) and/or who is talking to whom (quality of service), for example. There is now an increased emphasis on access control (security), which requires reserved fields to be used for routing (e.g. R_CTL). Accordingly, the router extension described above according to embodiments of the invention can be used to implement routing that can provide this increased level of security. The route response can include information such as operations that were prohibited due to security reasons.

The centralized router 106 of FIG. 1 provides granular control over the crossbar switch and knowledge of which ports are connected to each other, which can be used to improve fairness and quality of service. Centralized router 106 also allows for burst routing, in which a route can be opened to allow for the transfer of 4-5 packets, for example. However, embodiments of the invention can be applicable to distributed routers as well. In distributed router embodiments in which the router is distributed amongst the various port control modules 102, each distributed router may need a FSM to be able to determine when to pass the request out to the interface.

Embodiments of the invention can also be applicable to FCOE. In FCOE, where storage traffic is communicated over the existing Ethernet infrastructure, a frame may include Ethernet headers with fields that can also be used to direct route requests off chip. However, in previous storage-over-Ethernet standards such as iSCSI (SCSI over IP over Ethernet), the IP layer used TCP/IP and introduced significant delay. With FCOE, a FC frame is wrapped in an Ethernet frame with no Internet Protocol (IP) layer, and because it is tunneled, it is point-to-point and introduces minimal delay.

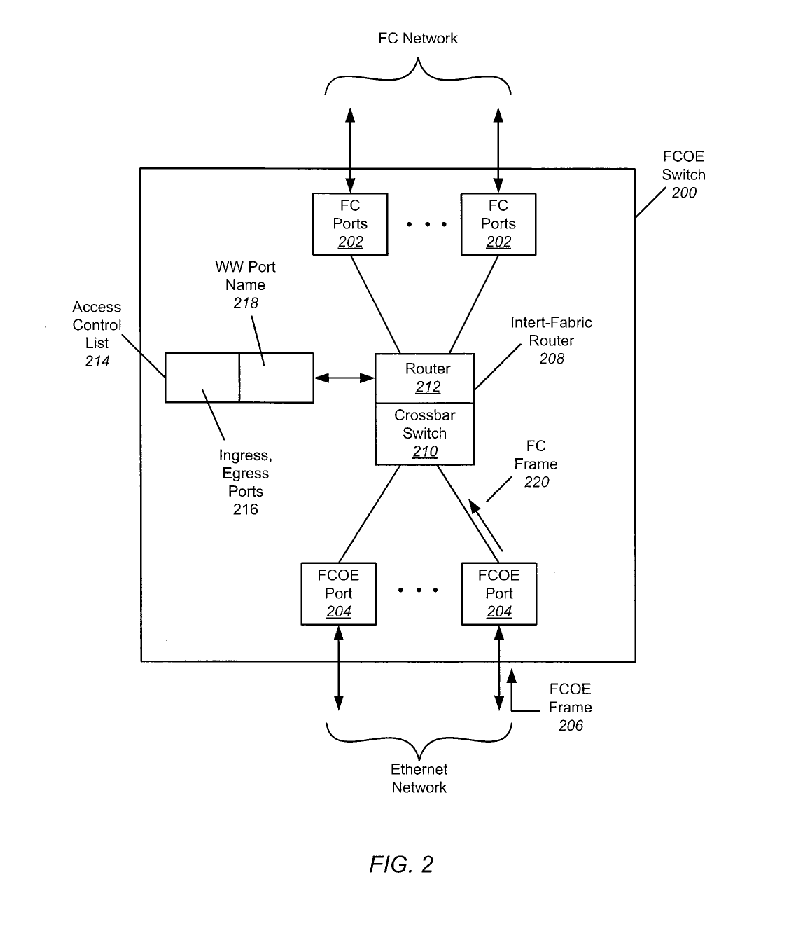

FIG. 2 illustrates an exemplary Fibre Channel Over Ethernet (FCOE) switch 200 employing off-chip routing according to embodiments of the invention. In other words, switch 200 is an Ethernet switch that is FCOE-aware. In the example of FIG. 2, FCOE switch 200 includes a number of regular FC ports 202 for connecting to FC devices over a FC link, and a number of FCOE ports 204 for connecting to FCOE-compatible devices over the Ethernet. FCOE switch 200 also includes an inter-fabric router (IFR) 208, which includes a crossbar switch 210 and a router 212. Router 212 may have access to an access control list (ACL) 214, which can include ingress and egress port information 216 and a World-Wide Port Name (WWPN) 218. Router 212 may see the ACL 214 and base its route on information on the ACL. In FIG. 2, a FCOE device can send a FCOE frame 206 to an FCOE port 204 in switch 200. The FCOE port 204 can strip off the Ethernet layer and transmit just the FC frame 220 to crossbar switch 210.

FCOE frames may utilize access control lists (ACLs) that have media access control (MAC) world-wide names (WWNs), and routing may need to be based on World-Wide Port names and ingress and egress ports. To extend ACLs that work in local area network (LAN) environments to FCOE, additional fields in the header of the FC frame may be needed. Therefore, deep packet inspection may be needed to read these fields in the FCOE frames. However, deep packet inspection is not needed for standard FC frames, and performing deep packet inspection on every frame would introduce delays. External router extensions according to embodiments of the invention can be used to route based on these ACLs. In one embodiment, the external router extension may be a content addressable memory (CAM).

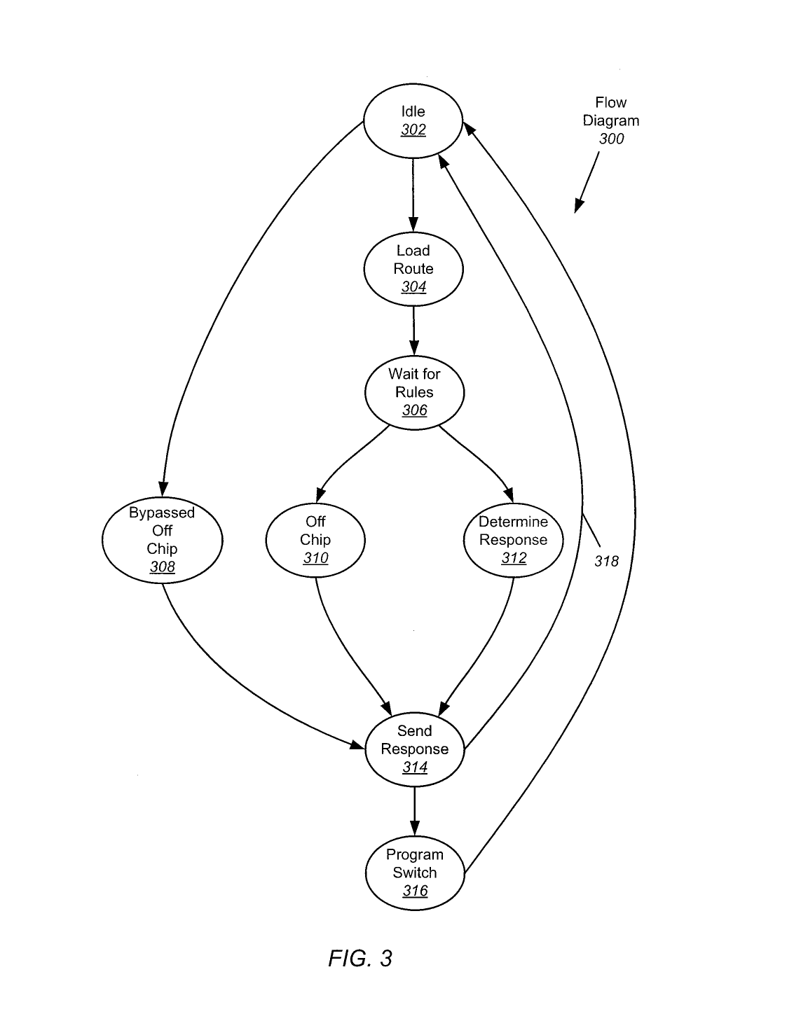

FIG. 3 illustrates a flow diagram 300 of an exemplary finite state machine (FSM) in an on-chip router capable of utilizing off chip routing logic according to embodiments of the invention. In the example of FIG. 3, the process begins at idle state 302. When a route request is received from a PCM, two states are possible from the idle state 302, based on the fields of the route request. One state that can be reached, if known in advance by firmware, is that the on-chip router is to be bypassed at 308. If bypassing is not known in advance, the route request is loaded into the internal FSM at state 304, where it is presented to the routing rules engine, which has all of the preprogrammed rules for normal routing, along with some fields that instruct the FSM to look for a special R_CTL bit or S_ID/D_ID pair, for example. At state 306, the process waits for the routing rules engine to apply its rules to the route request. When the rules have been applied, two states are possible. For example, if certain fields are found, the route request can be forwarded off-chip at state 310. This may be utilized if the route request is unrecognized, in which case it can be sent off-chip with a presumption that the off-chip router can process it. However, if other fields are found, normal on-chip processing occurs and a route response can be determined at 312. When a route and route response have been determined by either the off-chip route rules engine or on-chip route rules engine, the route response can be sent back to the requesting PCM and the crossbar switch is then programmed at 316. After the switch is programmed, there is a return to the idle state 302. However, if for some reason no route is to be performed (e.g. a security issue or undetermined route), then instead of programming the switch, there is a direct return to the idle state at 318.

In block 306, or from the idle state 302, the routing rules engine can base its routing response on a number of parameters, including but not limited to, route direct (an indicator that a route is to be made between two specific ports, regardless of what is in the headers), D_ID, S_ID, R_CTL, ingress port, type, and payload (certain fields from FCSP, other headers).

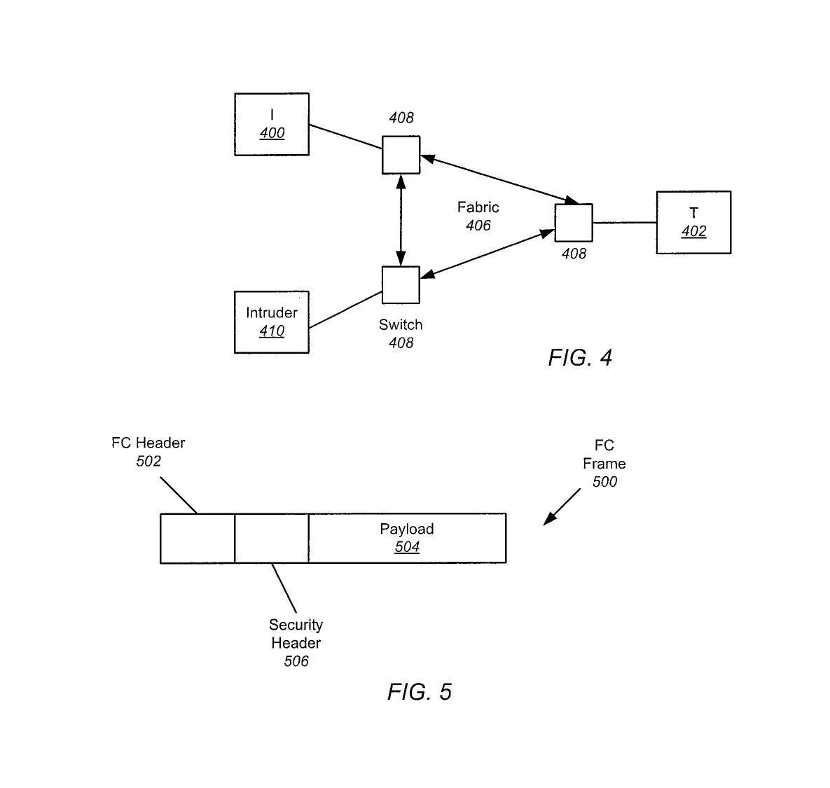

FIG. 4 illustrates an exemplary denial of service scenario that could be mitigated by the external router capabilities provided by embodiments of the invention. In the example of FIG. 4, an initiator 400 with a particular S_ID and protocol type (e.g. SCSI, control, video, streaming, etc.), and potentially information in a security header wants to communicate with a target 402 with a particular D_ID and type over a fabric 406 including multiple switches 408. Any information that uniquely identifies the data stream can be useful to switches 408, because an intruder 410 with the same S_ID and type as the initiator can spoof some of the same fields in the frame and overload the target with traffic. Therefore, a deep packet inspection can be employed to inspect and route based on all of the fields to avoid the intruder. However, deep packet inspection may not be performed in all switches, only on certain switches in the network. Routing based on deep packet inspection is an example of routing logic that could be placed in the off-chip router extension.

FIG. 5 is a drawing of an exemplary FC frame 500, with a FC header 502 and payload (data) 504 with a security header capable of being used by a router extension according to embodiments of the invention. There is also an optional security header 506 containing the FC security protocol (FC-SP). The FCSP can be used to differentiate traffic flows. Although it may be possible to spoof the FC header, it can be difficult to spoof the FCSP header, thereby increasing security.

The external router interface can also provide a mechanism for allowing the processor in the ASIC to program the routing modes and tables on the external device.

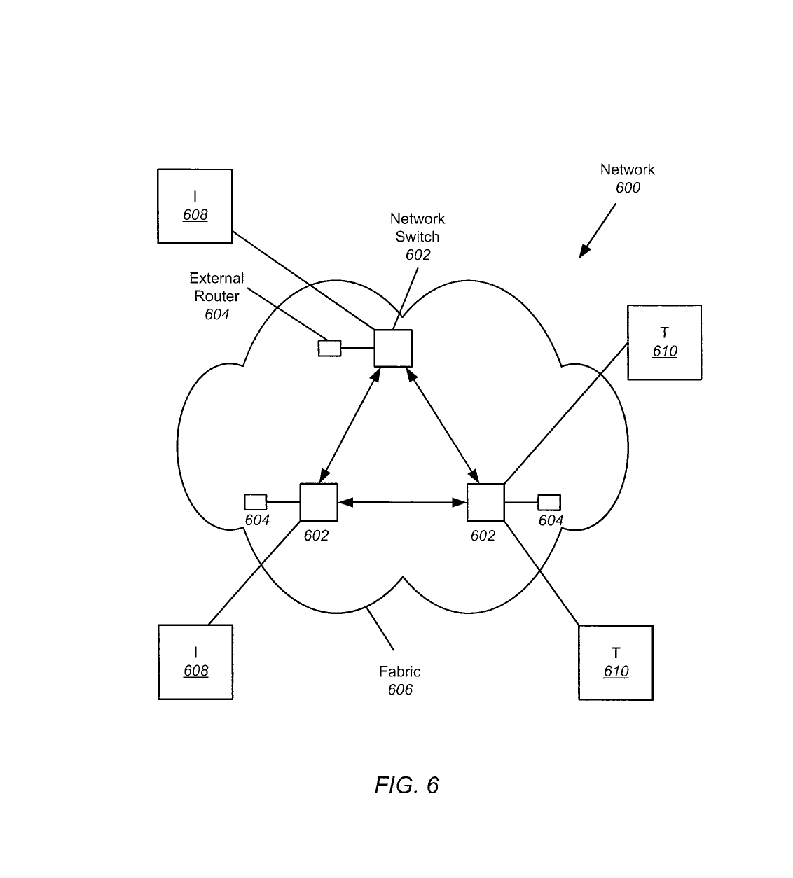

FIG. 6 illustrates an exemplary generalized network configuration 600 including network switches 602 having external router connections for connecting to external routing logic 604 according to embodiments of the invention. Note that the external routing logic 604 is shown as a separate box but can also be co-resident on the switch main printed circuit board. In the example of FIG. 6, the switches form part of fabric 606, and devices such as initiators 608 and targets 610 may be connected to any number of switches 602. Switches 602 may include, but are not limited to, FC switches and SAS expanders. Switches 602 having external router connections can be advantageous to the overall network because the external router connections allow for configurable and upgradeable external routing logic to provide additional routing capabilities such as improved security (authentication and encryption), quality of service, and deeper levels of zoning support.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claimed is:

1. A network switch ASIC, comprising:
one or more ports configured for receiving frames from the network and generating route requests;
an internal router coupled to one or more of the ports, the internal router configured for receiving a route request and, based on the route request, either generating route programming information for creating a route within the internal router or forwarding the route request to an external router for generating a route response; and
a router extension port coupled to the internal router and configured for forwarding the route request to an external router and receiving the route response from the external router.

2. The network switch ASIC of claim 1, wherein the internal router generates the route programming information for creating the route based only on the route response received from the external router.

3. The network switch ASIC of claim 1, wherein the internal router generates the route programming information for creating the route based on the route response received from the external router and its own route determination.

4. The network switch ASIC of claim 1, the one or more ports further configured for generating route requests having one or more bits indicating whether the internal router should forward the route request to the external router.

5. The network switch ASIC of claim 1, the one or more ports further configured for generating route requests including frame header information for enabling advanced routing capabilities.

6. The network switch ASIC of claim 1, the internal router including arbitration logic for determining whether the internal router, external router, or both should process the route request.

7. The network switch ASIC of claim 6, the internal router and external router configured for operating synchronously when both are processing the route request.

8. The network switch ASIC of claim 1, the network switch ASIC coupled to an external router, the external router for receiving the route request and sending a route response back to the internal router.

9. The network switch ASIC of claim 1, the network switch ASIC incorporated into a network switch.

10. The network switch ASIC of claim 9, the network switch incorporated into a storage area network.

11. The network switch ASIC of claim 1, the ports being coupled to at least one of converged Ethernet links capable of supporting FCoE frames, SAS links, SATA links, PCIe links capable of supporting multiroot IOV, and Ethernet links.

12. An external router for providing routing functionality to a network switch ASIC, comprising:
one or more finite state machines configured for receiving a route request from an internal router in the network switch ASIC and providing a route response back to the internal router, the route response including a response type and containing information for creating a route.

13. The external router of claim 12, the response type selected from a group consisting of route OK, reject, busy, discard, and disconnect timeout.

14. A method for generating route programming information for a network switch ASIC, comprising:
generating a route request based on one or more frames received from the network; and
based on the route request, selectively generating route programming information for creating a route within an internal router, or forwarding the route request to an external router for generating a route response.

15. The method of claim 14, further comprising generating the route programming information within the internal router for creating the route based only on the route response received from the external router.

16. The method of claim 14, further comprising generating the route programming information within the internal router for creating the route based on the route response received from the external router and its own route determination.

17. The method of claim 14, further comprising generating the route requests having one or more bits indicating whether the internal router should forward the route request to the external router.

18. The method of claim 14, further comprising generating the route requests including frame header information for enabling advanced routing capabilities.

19. The method of claim 14, further comprising determining within the internal router whether the internal router, external router, or both should process the route request.

20. The method of claim 19, further comprising operating the internal router and the external router synchronously when both are processing the route request.

21. A method for providing routing functionality to a network switch ASIC, comprising:
receiving a route request into an external router from an internal router in the network switch ASIC; and
generating a route response in the external router and sending the route response back to the internal router, the route response including a response type and containing information for creating a route.

22. The method of claim 21, the response type selected from a group consisting of route OK, reject, busy, discard, and disconnect timeout.
